(19) United States
(12) Patent Application Publication
(10) Pub. No.: US 2022/0095744 A1
(43) Pub. Date: Mar. 31, 2022

(54) WATERPROOF BREATHABLE FOOTWEAR

(71) Applicants: W. L. Gore & Associates GMBH, Putzbrunn (DE); W. L. Gore & Associati S. R. L., Verona (IT)

(72) Inventors: Stane Nabernik, Putzbrunn (DE); Martin Pfister, Putzbrunn (DE); Kerstin Schiller, Putzbrunn (DE); Nicotra Marco, Putzbrunn (DE); Andrea Giupponi, Verona (IT)

(21) Appl. No.: 17/427,085

(22) PCT Filed: Jan. 31, 2020
(86) PCT No.: PCT/EP2020/052517

§ 371 Date: Jul. 29, 2021

(30) Foreign Application Priority Data
Feb. 1, 2019 (IT) 202019000000383

(51) Int. Cl. A43B 23/02

(52) U.S. Cl. CPC A43B 23/0235; A43B 23/026; A43B 23/022

(57) ABSTRACT

A footwear article (15) comprises an upper assembly (1) and a sole assembly, wherein the upper assembly (1) comprises a monofilament layer (3), a functional layer (4, 8, 12) and a polymer grid (2), wherein the monofilament layer has a textile weight of less than 80 g/m2 and a thickness of less than 1 mm, wherein one surface of the monofilament layer (3) is laminated to the functional layer (4, 8, 12), wherein the polymer grid (2) is located on the surface of the monofilament layer (3) that is facing away from the functional layer (4, 8, 12).

### FIELD OF THE INVENTION

The present invention relates to footwear articles and more particularly to waterproof and breathable footwear articles.

### BACKGROUND OF THE INVENTION

Waterproof footwear articles are used for a large variety of purposes in working environments and for leisure. Such footwear articles provide protection from the elements, such as water, mud and snow while also providing durability. The wearer is kept comfortable by allowing water vapor to permeate through the footwear article to the outside. Typically, a membrane is used to render footwear articles waterproof and breathable and which is covered by textile layers in order to protect the membrane from mechanical damage. Increased durability and foot protection is particularly desirable for footwear used in working environments which require protective footwear such as for police, army or fire services. Addition of an additional material layer on the outside of the footwear article for protection against mechanical damage often leads to a reduced breathability and may result in the problem of the feet overheating, creating moisture in the footwear article and then conducting cold.

US 2013/000851 discloses a waterproof breathable boot including an outsole, a three-piece bootie, a toe cap, a heel cap, a center front panel, an instep panel and a rear panel. The toe cap, heel cap, and panels are made from a waterproof elastic material, such as rubber or Neoprene. However, the boot of US 2013/000851 still comprises large parts on the surface that are not protected against mechanical damage.

Thus, there is a need for footwear that is breathable and waterproof but also durable and comfortable.

### SUMMARY OF THE INVENTION

According to a first aspect of the present invention there is provided a footwear article comprising an upper assembly and a sole assembly, wherein the upper assembly comprises a monofilament layer, a functional layer and an polymer grid, wherein the monofilament layer has a textile weight of less than 80 g/m² and a thickness of less than 1 mm, wherein one surface of the monofilament layer is laminated to the functional layer, wherein a polymer grid is located on the surface of the monofilament layer that is facing away from the functional layer.

In embodiments the monofilament layer is a single layer.

The polymer grid may comprise polyurethane and optionally the polyurethane is a thermoplastic polyurethane.

The polymer grid forms the outermost surface of the footwear article. The polymer grid may be adapted to straddle any or all of the seams and/or cutting edges of the upper assembly

Before assembly of the footwear article, the upper assembly is completely open and can be spread out on a flat surface.

The seam closing the upper assembly in the heel portion may be located on the surface of the upper assembly that faces the outside of the footwear article.

A three or four layer bootie laminate or a two or three layer liner laminate may be attached on the surface of the upper assembly that faces the inside of the footwear article.

The seam closing the upper assembly in the heel portion may be located on the surface of the upper assembly that faces the outside of the footwear article. Alternatively, the seam closing the upper assembly in the heel portion may be located on the surface of the upper assembly that faces the inside of the footwear article.

A two or three layer liner laminate or a three or four layer bootie laminate may be located on the surface of the upper assembly that faces the inside of the footwear article.

The upper assembly may further comprise a reinforcement layer attached to the surface of the functional layer that is opposite to the surface which is attached to the monofilament layer. The reinforcement layer may also comprise or consist of monofilaments.

The two or three layer liner laminate or the three or four layer bootie laminate may be adhered to the reinforcement layer of the upper assembly.

The two or three layer liner laminate or the three or four layer bootie laminate may be adhered to the functional layer of the upper assembly.

A lining, for example a textile, a textile mesh, a fabric, a nonwoven, a woven, or a knit, may be attached to the functional layer of the upper assembly around the top of the upper assembly where the foot is inserted into the footwear article.

The footwear article may further comprise a waterproof seal between the upper assembly and the sole assembly.

### BRIEF DESCRIPTION OF THE DRAWINGS

Embodiments of the invention will now be more particularly described with reference to the drawings.

FIG. 1 shows the layers of an upper assembly.

FIG. 2 shows the layers of a three layer bootie laminate.

FIG. 3 shows the layers of a three layer liner laminate including the adhesive for attachment to the upper assembly.

FIG. 4 shows a footwear article according to the present invention.

FIG. 5 shows a cross sectional view of a footwear article according to the present invention.

FIG. 6 shows a cross sectional view of a footwear article according to the present invention.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The term footwear or footwear article refers to outer coverings for feet such as shoes, boots, sandals, trainers, sneakers and the like. The footwear articles of the present invention comprise an upper assembly and a sole assembly.

The upper assembly comprises a monofilament layer, a functional layer and a polymer grid, wherein the monofilament layer has a textile weight of less than 80 g/m² and a thickness of less than 1 mm, wherein one surface of the monofilament layer is laminated to the functional layer, wherein a polymer grid is located on the surface of the monofilament layer that is facing away from the functional layer.

Monofilament Layer

The term monofilament refers to a single strand of polymer. At least one polymer and optionally at least one additive are mixed and then melted. The melted polymer mixture or polymer/additive mixture is extruded through holes forming the strands.

Monofilaments have a homogenous structure and moisture, e.g. water vapour and/or liquid water, and/or any other liquids, may be absorbed by the monofilament only on a molecular scale, i.e. by incorporation of molecules into the molecular structure of the monofilament material.

The monofilaments may have a water absorption rate of less than 40% according to the “Bundesmann test” as described in DIN EN 29685 (1991). In further embodiments, the monofilaments may have a water absorption rate of less than 30%, less than 25% according to DIN EP 29685 (1991). In some embodiments, the monofilaments may have a water absorption rate of 20% to 35% according to DIN EN 29685 (1991).

Water absorption rate as used herein, refers to a water absorption rate of the monofilaments as measured using a laminate made from a functional layer (e.g. an ePTFE functional layer as described below) and a monofilament layer. In such laminate the functional layer serves as a carrier for the monofilament layer. Water absorption is measured on the side of the monofilament layer in an experimental setup as described in detail in DIN EN 29685 (1991).

The monofilament layer has a knit and/or woven configuration formed of monofilaments interlaced with each other to form loops, meshes and/or interstices between weft and warp yarns. Thus, the monofilament layer comprises a large number of interstices in between the monofilaments. Also, the interstices formed in the monofilament layer may be relatively large, and thus do not provide for significant capillary function. Rather, moisture is transported through the interstices formed by the monofilament layer towards the functional layer.

The monofilament layer may be knit fabric. As used herein, the term “knit fabric” refers to any fabric or textile having a configuration with at least one yarn, thread or monofilament turned into consecutive rows of loops, called loop stitches. As each row progresses, a new loop is pulled through an existing loop. The active loop stitches are held on a needle until another loop can be passed through them.

In the process of knitting a fabric is formed by the intermeshing of loops of yarn, yarns or monofilaments. Each thread of yarn or monofilament follows a meandering path, called course, thus forming loops symmetrically to the meandering path of the thread. When one loop is drawn through another, loop stitch is formed. Loop stitches may be formed in horizontal (weft knitting) or vertical direction (warp knitting). A sequence of loop stitches in which each stitch is suspended from the next is called a wale.

Weft knitting is a method of forming a fabric in which the loops are made in horizontal way from a single yarn or monofilament, and intermeshing of loops takes place in a crosswise direction, i.e. the wales are perpendicular to the course of the yarn or monofilament. Weft knitting may be knit using only one yarn or monofilament, or using a multiplicity of yarns or monofilaments.

Warp knitting is a method of fabric forming in which the loops are made in a vertical way along the length of the fabric from each warp yarn or monofilament, and intermeshing of loops takes place in a lengthwise direction. In warp knitting, the wales and courses run parallel. One yarn or monofilament is required for each wale, thus numerous ends of yarns or monofilaments are being fed simultaneously to individual needles placed in a lateral direction.

Knits or knitted fabrics, as used herein also include nettings—wherein the monofilaments are connected by knots—and braids from interlaced strands of monofilaments.

The monofilament layer may be lightweight. The monofilament layer may have a textile weight of less than 80 g/m². The textile weight of the monofilament layer may be less than 70 g/m², or less than 60 g/m². In some embodiments, the textile weight of the monofilament layer may be in the range of 40 g/m² to 70 g/m².

The monofilament layer may be a single layer, for example a single fabric layer. The monofilament layer has a thickness of less than 1 mm. Optionally, the monofilament layer has a thickness of less than 0.9 mm or 0.7 mm.

In embodiments, the monofilament layer has not been treated to be durable water repellent (DWR).

Functional Layer

The term “functional layer” refers to materials which are both waterproof and water vapor permeable membranes.

A functional layer or a laminate comprising a functional layer are considered to have waterproof characteristics when the requirements specified in DIN EN 343 (2010) are met, i.e. a test of the liquid water resistance with respect to hydrostatic water pressure according to EN 20 811 (1992) yields a liquid water resistance Wp of 8000 Pa, or more.

Water vapor permeability of the functional layer or the laminate comprising the functional layer is tested and defined in EN ISO 15496, also known as the “Cup Test”. A 20 cm×20 cm or a circular ra 100 mm sample of the functional layer or laminate comprising the functional layer is placed onto a container containing water and covered with a water vapor permeable and waterproof membrane. Then a cup containing potassium acetate and being covered by the same membrane is placed on the sample. Water vapor passes through the functional layer or the laminate comprising the functional layer into the cup, whose weight increase is then determined. The functional layer or laminate comprising the functional layer is considered water vapor permeable or breathable if the water vapor permeability is greater than or equal to 0.01 g/(Pa m² h). If the required size of the sample cannot be obtained, a smaller sample may be used for the measurement using a smaller cup containing half the amount of potassium acetate specified in the Norm, i.e. 50 g instead of 100 g and mixed with 15.6 g of water. The terms water vapor permeability and breathability are used interchangeably herein.

According to an embodiment, the functional layer comprises at least one of expanded polytetrafluorethylene (ePTFE), polyurethane (PU), polyester (PES) and copolyether ester, polyether, polyamide (PA), copolyether amides and polyacrylate, and other suitable thermoplastic and elastomeric films. The functional layer may be made of a fluoropolymer, particularly made of microporous expanded polyterafluorethylene (ePTFE).

The microporous polytetrafluoroethylene functional layer is a membrane of expanded polytetrafluoroethylene as taught in U.S. Pat. Nos. 3,953,566 and 4,187,390. Such membranes of expanded polytetrafluoroethylene are present in commercially available fabrics from W. L. Gore and Associates, under the tradename GORE-TEX® fabric. The water vapor permeable and waterproof membrane may be composed of a polyurethane coated microporous expanded polytetrafluoroethylene membrane made substantially according to the teachings of U.S. Pat. Nos. 4,194,041 and 4,942,214 assigned to W. L. Gore and Associates, Inc, in Elkton, Md.

Polymer Grid

A polymer grid is located on the surface facing the outside of the footwear article on the upper assembly and is adhered to the surface of the monofilament layer. The polymer of the polymer grid may be selected from polyurethanes, polyamides, polyethylenes or any mixture thereof. The polymer grid may comprise polyurethane. In embodiments, the polyurethane is thermoplastic polyurethane (TPU). TPU is a block copolymer consisting of alternating sequences of hard and soft segments or domains formed by the reaction of diisocyanates with short-chain and long chain diols.

The polymer grid may be injected over or poured or be applied with any other polymeric technology onto the monofilament layer. Alternatively, the polymer grid may be high frequency or ultrasonic welded or heat pressed onto the monofilament layer. The polymer grid may have a regular geometric pattern, for example with repeating shapes. The polymer grid may have a random pattern.

The polymer grid may comprise straight stripes of polymer, curved stripes of polymer, crossing stripes of polymer, parallel stripes of polymer or any combination thereof. The stripes of polymer may have a width of 0.5 mm to below 3 mm. The stripes of polymer may outline shapes such as squares, triangles, hexagons, pentagons or other polygons; circles; ovals or any combination thereof. The polymer grid may comprise bands of polymer. Such a band of polymer may have a width of 3 mm to 4 cm. The bands of polymer may differ in width and length and may be straight or bent. The polymer grid of the footwear article may comprise any combination of the above.

The polymer grid may provide the outer surface of the footwear article. The polymer grid may be adapted to straddle any seams and/or cutting edges of the upper assembly. The term “straddle” is used to describe the polymer grid to extend across the seam thus adhering to both surfaces that are connected through the seam.

The upper assembly may have been cut into the shape of a footwear upper. The polymer grid may further be adapted to straddle the seam or seams where the tongue is attached to the footwear upper assembly.

Reinforcement Layer

Optionally, the upper assembly may comprise a reinforcement layer bonded to the surface of the functional layer that faces away from the monofilament layer.

The reinforcement layer may be a textile layer. The reinforcement layer may comprise filaments, such as monofilaments, or fibers, or any mixtures thereof. Fibers include natural and synthetic fibers and any mixtures thereof. Natural fibers include cellulosic types such as cotton, hemp or linen; animal fibers such as silk, angora, sheep's wool, alpaca, cashmere, mohair and any combination thereof.

Synthetic fibers include fibres based on acrylic polymers, polyesters, polyolefins, polyurethanes and any combination thereof.

The reinforcement layer may be knit fabric as described above, a woven fabric or a non-woven fabric.

Woven fabric refers to a fabric formed by weaving. Weaving is a process of fabric forming by the interlacement of warp and weft yarns. Both warp and weft yarns run essentially straight and parallel to each other, either lengthwise (warp) or crosswise (weft). Woven fabric only stretches diagonally on the bias directions (between the warp and weft directions), unless the threads are elastic.

Non-woven fabric refers to a fabric-like material, such as felt, which is neither woven nor knitted. Non-woven fabric is made from fibres, bonded together by chemical, mechanical, heat or solvent treatment.

The reinforcement layer may be durable water repellent (DWR). DWR is a treatment of coating, immersing or spraying a hydrophobic agent to fabrics to render them water-resistant or hydrophobic. Preventing the fabric from becoming saturated with water avoids reduction of the breathability of the functional layer.

Bonding of the monofilament layer and/or the reinforcement layer to the functional layer may be achieved by thermo-adhesive glue. Powder of adhesive, for example polyurethane (PU) based adhesive may be distributed on the surface of the functional layer. Alternatively, if the adhesive is of the hotmelt type, dots of adhesive having a diameter of from 0.1 to 2.0 mm and a density from 50 to 600 dots/cm² may be applied to the surface of the functional layer. The thermo-adhesive glue may be sprayed onto the surface that is to be attached. The thermo-adhesive glue may be applied to the surface that is to be attached in any regular or irregular pattern.

Heating the different components to a temperature above the melting point of the adhesive will bond the different layers to form a laminate. Typically, a temperature of 100 to 150° C. for 5 to 20 seconds and application of pressure result in a vapour-permeable waterproof laminate.

The polymer grid is attached to the monofilament layer as discussed above.

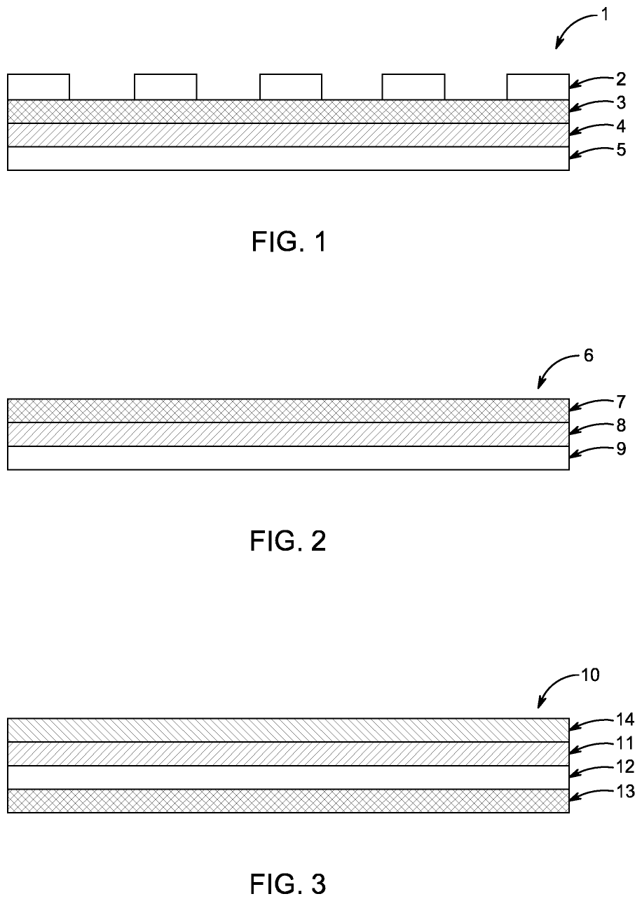

FIG. 1 shows the material construction of an upper assembly (1) comprising a polymer grid (2), a monofilament layer (3) and a functional layer (4). The embodiment of FIG. 1 further comprises a reinforcement layer (5).

When the upper assembly is being closed to assemble the 3D shape of the upper of the footwear article the open heel region can be closed by a stitched seam which is then sealed.

Sealing can be done with the help of a sealing tape that is attached above the seam, by 3D printing, by welding or gluing. The seam can be sealed on the surface that will face the outside of the footwear article or the surface that will face the inside of the footwear article. If the seam is sealed on the surface facing the inside of the footwear article and a reinforcement layer is present, then the reinforcement layer needs to be added after the seam sealing and with the upper assembly already being in a 3D configuration. If the seam is on the surface facing the outside of the footwear article, the polymer grid may be adapted to straddle the seam.

Particularly suitable as a seam sealing tape is a waterproof adhesive tape available from W. L. Gore Associates GmbH under the trade name GORE-SEAM®, which is a two-ply laminate having a waterproof, water-vapor-permeable functional layer and a textile layer and is provided, on the functional layer side, with a continuous adhesive layer in the form of a polyurethane adhesive, having a melting point of about 130° C. As seam sealing tape, a two-ply laminate cut into band shape can be used, with a thin, mechanically strong textile layer being provided instead of lining layer. Such seam sealing tape is available in various widths, with a width of 22 mm being preferred.

The upper assembly may comprise a tongue. The tongue may be a strip of the same monofilament layer and functional layer material of which the upper is made and which is arranged at the fastening region of the upper assembly, e.g. by sewing on or one-piece with the upper assembly material. Alternatively or in addition, the tongue may be made from an elastic laminate comprising a waterproof and breathable layer. The elastic laminate may comprise a polyurethane coated elastomer monofilament. The polymer grid may be adapted to straddle the seal between the upper assembly and the tongue or attach the tongue to the upper assembly. Alternatively, the tongue seam can also be sealed e.g. by the application of a seam sealing tape as described above or by a thermoplastic polyurethane (TPU) film which is cut out and applied on the surface of the upper assembly that is facing the inside of the footwear article.

Lacing may be integrated into the polymer grid. Optionally, the polymer grid provides the eyelets for threading through the laces.

The collar region of the footwear article may comprise the same material as the tongue or a different laminate. Preferably the collar region comprises an elastic laminate as disclosed with regard to the tongue.

In embodiments, a three or four layer bootie laminate may be placed on the inside of the upper assembly described above. The three layer bootie laminate may comprise a functional layer sandwiched between two textile layers. The four layer bootie laminate comprises a further textile layer on the surface of the textile layer facing the inside of the footwear article.

The functional layer may be selected from the functional layers as described above with regard to the upper assembly. The two textile layers of the three layer bootie laminate or the three textile layers of the four layer bootie laminate may be independently selected from knit fabrics, woven fabrics and non-woven fabrics as described above in relation to the reinforcement layer. The textile layers may comprise natural or synthetic fibers or monofilaments, all as described above with regard to the upper assembly. In embodiments the two or three textile layers of the three or four layer bootie laminate may be independently selected from polyamide (PA) knit fabrics or polyester (PES) knit fabrics. The textile layer of the four layer bootie laminate facing the inside of the footwear article may comprise hydrophilic fibers and/or thermally insulating fibers.

All three or four layers of the three or four layer bootie laminate may be attached to each other using an adhesive, for example a thermo-adhesive glue as described with regard to the bonding of the monofilament layer.

The three or four layer bootie laminate may be formed as a three-dimensional bootie, insert or sock. The three-dimensional bootie of the three or four layer bootie laminate may have at least one seam or the three-dimensional bootie of the three or four layer bootie laminate may be seamless. The seam(s) may be sealed by a seam tape as described above.

The three or four layer bootie laminate may be attached to the upper assembly at the collar region.

In embodiments, the attachment at the collar region is a stitched seam. Additionally, the three or four layer bootie laminate may be selectively bonded to the upper assembly for example by using thermo-adhesive glue. The adhesive may be applied in distinct areas e.g. in the toe area and/or the heel area and/or the sole area. The adhesive may be applied as described with regard to the bonding of the monofilament layer.

FIG. 2 depicts a three layer bootie laminate (6) comprising a functional layer (8) sandwiched between two textile layers (7) and (9).

In an alternative embodiment, a two layer liner laminate comprising a functional layer and a textile layer is adhered to the inside of the upper assembly such that the textile layer of the two layer liner laminate faces the inside of the footwear article.

Optionally, a further textile layer may be adhered to the surface of the functional layer of a two layer liner laminate facing the upper assembly to form a three layer liner laminate. The functional layer is then sandwiched between two textile layers in the three layer liner laminate.

The functional layer of the two or three layer liner laminate may be selected from the functional layers described above in relation to the upper assembly. The textile layer(s) of the two or three layer liner laminate may be selected from knitted fabrics, woven fabrics and non-woven fabrics.

In embodiments, the textile layer closest to the inside of the footwear article comprises hydrophilic fibers. Alternatively or in addition, the textile layer closest to the inside of the footwear article, preferably the second textile layer, may comprise a fibrous thermally insulating material.

The two or three layer liner laminate may be attached to the upper assembly at the collar region.

In embodiments, the attachment at the collar region is a stitched seam. Additionally, the two or three layer liner laminate may be bonded to the upper assembly for example by using thermo-adhesive glue. The thermo-adhesive glue may be applied as disclosed with regard to the bonding of the monofilament layer.

FIG. 3 discloses a three layer liner laminate (10) comprising a textile layer (11), a functional layer (12) and a further textile layer (13). The three layer laminate (10) may be laminated to the upper assembly using a thermo-adhesive glue (14).

The upper of the footwear article comprising the upper assembly and any of the bootie or liner laminates is then closed by sewing or gluing the upper assembly as well as the respective bootie or liner laminate to an assembly insole. The assembly insole may be any known insole, for example lasting boards or Strobel boards. After closing of the upper, the sole assembly is associated with it. The sole assembly may be a single block which is attached to the upper of the footwear article with adhesive. To obtain high abrasion resistance and sole stability, materials used include rubber or polymers, for example polyurethane (PU).

Alternatively, the sole assembly may be made from a polymeric material such as polyurethane, thermoplastic polyurethane (TPU) or ethylene vinyl acetate (EVA) and injected over the bottom of the upper of the footwear article.

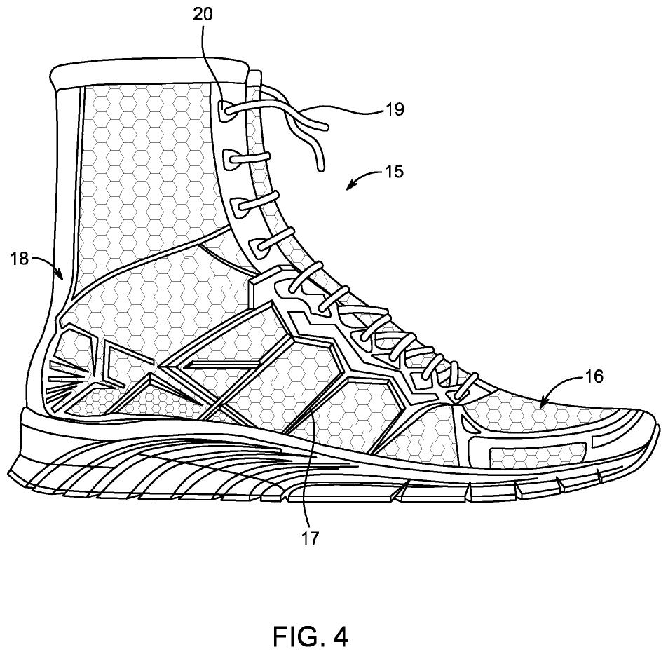

FIG. 4 discloses a footwear article (15) comprising an upper assembly and a sole assembly. The upper assembly is covered by a polymer grid comprising a regular geometric pattern (16), stripes (17) and bands (18) of polymer. The lacing (19) is incorporated into the polymer grid which provides the eyelets (20) for fastening of the lacing.

In alternate embodiments, the footwear article does not comprise the three or four layer bootie laminate in order to render the footwear article waterproof and breathable. The construction of the upper assembly allows for the footwear article of the present application to be waterproof when a sole assembly is attached as water cannot be transported through the upper assembly. No further gasket or waterproof membrane is required.

The upper assembly may be closed and attached to the sole assembly for example in a lasting construction or a Strobel construction.

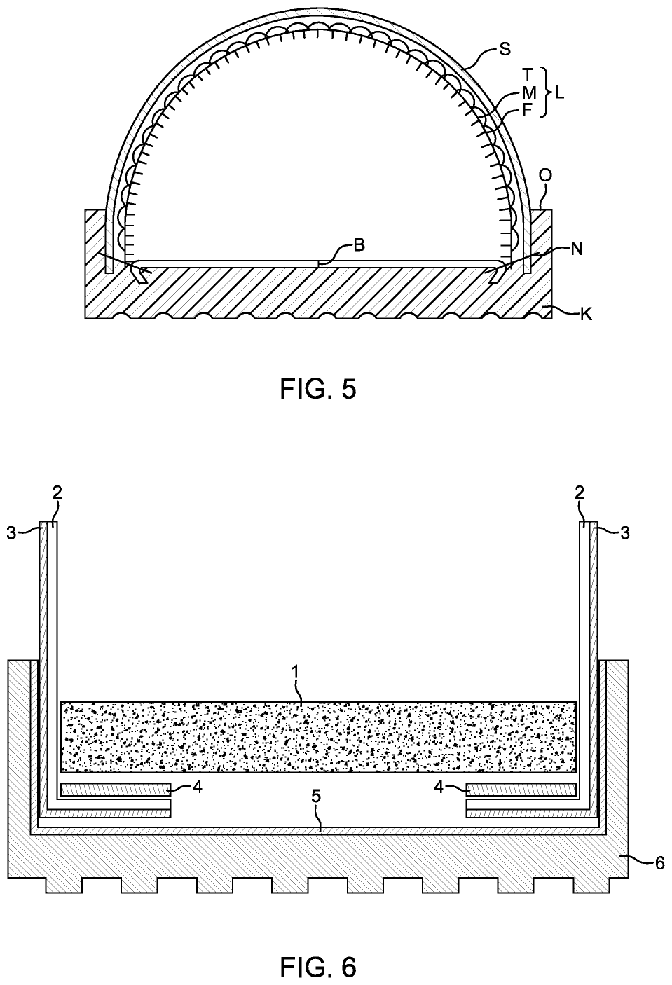

FIG. 5 discloses a footwear article having an insole (B) which is attached to the upper assembly by sewing, such as for example by using the Strobel technique (Strobel construction). A seam (N) connects the insole (B) with the upper (S and L). FIG. 5 depicts and upper comprising a polymer grid (S), a monofilament layer (T), a functional layer (M) and a reinforcement layer (F). The upper assembly may be any of the upper assemblies disclosed in this application comprising a polymer grid, a monofilament layer, a functional layer and optionally a support layer. The insole may be a Strobel board.

The sole assembly (K, O) may be attached either by adhering a pre-formed outer sole or by injection moulding. The sole assembly may be a single block which is attached to the upper of the footwear article with adhesive or sole cement. To obtain high abrasion resistance and sole stability, materials used for the single block of sole assembly include rubber or polymers, such as for example polyurethane (PU).

If the sole assembly is provided by injection moulding, liquid sole material is injected over the bottom of the upper assembly. The sole assembly may be made from polymeric material such as polyurethane (PU), thermoplastic polyurethane (TPU) or ethylene vinyl acetate (EVA). The sole assembly may also be poured or moulded over the bottom of the upper assembly.

In the lasting construction, an example of which is depicted in FIG. 6, an upper assembly is drawn over a last. The upper assembly comprises a polymer grid shown as layer (3) in FIG. 6, and shown as combined layer (2) are the monofilament layer, the functional layer and optionally the reinforcement layer, all as previously described in this application. Any upper assembly disclosed in the present application can be used for this lasting construction.

The opening at the bottom of the upper assembly is then closed with an insole (1). The insole can be made from any material typically used for insoles. The upper assembly is drawn around the edges of the insole and then attached to the insole using a waterproof adhesive (4). In embodiments, the insole is waterproof. The waterproof adhesive is preferably a polyurethane-based reactive hotmelt adhesive. Reactive hotmelt adhesive is adhesive which is rendered waterproof in the fully reacted state. Preferably, the waterproof adhesive is a thermoplastic adhesive. The thermoplastic adhesive may comprise polyester and/or polyamide.

The polymer grid (3) may be present in the portion of the upper assembly that is folded around the insole (1) and thus located underneath the insole (1). In embodiments, only the monofilament layer, functional layer and optionally the reinforcement layer may be drawn around the insole such that the polymer grid only covers the monofilament layer outside of the sole assembly. A sole assembly is attached to the upper.

The sole assembly may be attached either by adhering a pre-formed outer sole or by injection moulding. The sole assembly may be a single block (6) which is attached to the upper of the footwear article with adhesive or sole cement (5). This adhesive or sole cement may be a polyurethane adhesive. Preferably, the adhesive or sole cement is not a hotmelt adhesive. To obtain high abrasion resistance and sole stability, materials used for the single block of sole assembly include rubber or polymers, such as for example polyurethane (PU).

In embodiments, when the sole assembly is attached to the upper assembly with adhesive or sole cement, a gasket (not shown in the figures) may be attached to the insole and the portion of the upper assembly that is drawn around the last. In this portion, of the upper assembly the gasket is preferably attached to the layer of the upper assembly that faces the outside of the footwear article. In order to provide an even surface underneath the wearer's foot, a bottom filler may be attached underneath the gasket. The gasket is sandwiched either between the insole and the sole assembly or the insole and the bottom filler.

If the sole assembly is provided by injection moulding, liquid sole material is injected over the bottom of the upper assembly. The sole assembly may be made from polymeric material such as polyurethane (PU), thermoplastic polyurethane (TPU) or ethylene vinyl acetate (EVA). Attachment of the sole assembly to the upper assembly seals the footwear article in a waterproof manner.

The upper assembly construction may also be a hybrid construction (not shown in the figures). For example, if a separate lining is used, this may be either connected by seam (N) to the insole (B) together with the polymer grid (S), a monofilament layer (T), a functional layer (M) and optionally a reinforcement layer (F) or only the lining can be sewn, whilst the polymer grid (S), a monofilament layer (T), a functional layer (M) and optionally a reinforcement layer (F) or part of these, are attached, for example by lasting, to a separate insole as are layers (2) and (3) in FIG. 6. Part of layers (S), (T), (M) and/or (F) means for example only in the toe area or the heel area of the footwear article.

For warmth or comfort, a further lining may be positioned on the inside of the upper assembly. This lining may only be attached at the collar of the footwear article by stitching. Alternatively, the lining may be attached at the collar of the footwear article and to the insole together with the upper assembly by stitching. For a lasted construction, the lining may be drawn around the insole together with the upper assembly and attached to the upper assembly by stitching. In a further embodiment, the lining may be laminated on the inside of the upper assembly.

1. A footwear article comprising:
an upper assembly and a sole assembly,
wherein the upper assembly comprises a monofilament layer, a functional layer and a polymer grid,
wherein the monofilament layer has a textile weight of less than 80 g/m² and a thickness of less than 1 mm,
wherein one surface of the monofilament layer is laminated to the functional layer,
wherein a polymer grid is located on the surface of the monofilament layer that is facing away from the functional layer.

2. The footwear article according to claim 1, wherein the monofilament layer is a single layer.

3. The footwear article according to claim 1, wherein the polymer grid comprises polyurethane.

4. The footwear article according to claim 3, wherein the polyurethane is thermoplastic polyurethane.

5. The footwear article according to claim 1, wherein the polymer grid is adapted to straddle any seams and/or cutting edges of the upper assembly.

6. The footwear article according to claim 1, wherein a seam closing the upper assembly in the heel portion is located on a surface of the upper assembly that faces the outside of the footwear article.

7. The footwear article according to claim 1, wherein a two or three layer liner laminate or a three or four layer bootie laminate is located on a surface of the upper assembly that faces the inside of the footwear article.

8. The footwear article according to claim 1, wherein the upper assembly further comprises a reinforcement layer attached to a surface of the functional layer that is opposite the surface that is attached to the monofilament layer.

9. The footwear article according to claim 7, wherein the two or three layer liner laminate or the three or four layer bootie laminate is adhered to the reinforcement layer of the upper assembly.

10. The footwear article according to claim 1, further comprising a waterproof seal between the upper assembly and the sole assembly.
